(19) United States
(12) Patent Application Publication
(10) Pub. No.: US 2025/0265655 A1
(43) Pub. Date: Aug. 21, 2025

(54) FINANCIAL LITERACY ENHANCEMENT IN THE METAVERSE

(71) Applicant: Wells Fargo Bank, N.A., San Francisco, CA (US)

(72) Inventors: Aparna M. Dave, Houston, TX (US); Craig Moore, Creve Coeur, MO (US); Paul W. Mussell, Minneapolis, MN (US)

(21) Appl. No.: 18/052,253

(22) Filed: Nov. 3, 2022

(51) Int. Cl. G06Q 40/06; G06Q 40/02; G06Q 40/03; G06Q 50/16; G06T 19/00

(52) U.S. Cl. CPC G06Q 40/06; G06Q 40/02; G06Q 40/03; G06Q 50/16; G06T 19/00

(57) ABSTRACT

Enhancing financial literacy using the metaverse. Visual, immersive financial content is provided via an augmented reality environment or a virtual reality environment. The content changes based on one or more financial factors, allowing users to visually and virtually experience and better understand how different prospective financial transactions are impacted by different financial factors of those transactions.

### BACKGROUND

The metaverse can be envisioned as an immersive world that is typically facilitated through the use of virtual and augmented reality devices. The metaverse can include a virtual representation of most, if not all, aspects of the physical work in which we live.

Major financial decisions and transactions, including those facilitated in the metaverse, are often made without a firm grasp by the individual of the financial factors that are relevant to the transaction, and without understanding how the transaction outcomes could change if the factors were to change.

### SUMMARY

Examples provided herein are directed to enhancing financial literacy by providing targeted immersive content using the metaverse.

According to one aspect, a computer system for enhancing financial literacy, includes: one or more processors; and non-transitory computer-readable storage media encoding instructions which, when executed by the one or more processors, causes the computer system to: when the computer system is operatively linked to a metaverse accessing device (MAD), create a metaverse environment with the MAD, the MAD being one of a virtual reality device or an augmented reality device, the metaverse environment including a visualization of an object, the object representing an aspect of a prospective financial transaction, the visualization being based on a financial factor of the prospective financial transaction; receive a modification of the financial factor; and when the computer system is operatively linked to the MAD, visually modify the visualization of the object based on the modification of the financial factor to provide a modified visualization of the object within the metaverse environment.

According to another aspect, a computer-implemented method for enhancing financial literacy, includes: creating a metaverse environment with a metaverse accessing device (MAD), the MAD being one of a virtual reality device or an augmented reality device, the metaverse environment including a visualization of an object, the object representing an aspect of a prospective financial transaction, the visualization being based on a financial factor of the prospective financial transaction; receiving a modification of the financial factor; and visually modifying the visualization of the object based on the modification of the financial factor to provide a modified visualization of the object within the metaverse environment.

According to another aspect, a system for enhancing financial literacy, includes: a metaverse accessing device (MAD), including a virtual reality device or an augmented reality device; one or more processors; and non-transitory computer-readable storage media encoding instructions which, when executed by the one or more processors, causes the MAD to: generate a metaverse environment including a visualization of a home, the home being selected for the visualization based on financial factors including a personal income amount and a mortgage interest rate, the metaverse environment including a dynamic adjuster for adjusting, by an avatar, a value of one of the financial factors; and replace or supplemented the visualization of the home with a visualization of a different home within the metaverse environment, the different home being selected based on an adjustment of the adjuster by the avatar within the metaverse environment.

The details of one or more techniques are set forth in the accompanying drawings and the description below. Other features, objects, and advantages of these techniques will be apparent from the description, drawings, and claims.

### DESCRIPTION OF THE DRAWINGS

FIG. 1 shows an example system for providing immersive, financial literacy enhancing content in a metaverse environment, in accordance with the present disclosure.

FIG. 2 shows example logical components, in accordance with the present disclosure, that can be stored on the database of the system of FIG. 1 and executed by the server device of the system of FIG. 1.

FIG. 3 shows an example method that can be performed using the system, or one or more portions thereof, of FIG. 1.

FIG. 4 shows a schematic representation of an example metaverse environment generated by the system of FIG. 2.

FIG. 5 shows a further schematic representation of the metaverse environment of FIG. 4.

FIG. 6 shows example physical components of the server device of FIG. 2.

### DETAILED DESCRIPTION

This disclosure relates to leveraging the metaverse to enhance financial literacy of metaverse users so that the users have a better understanding about financial transactions they make. The user's metaverse environment is augmented with immersive content related to a user's prospective financial transaction. The content includes visual content targeted at the specific transaction and one or more factors that are specific to that transaction.

There can be various advantages associated with the technologies described herein. For instance, immersive visual metaverse content can be particularly suited, and better than other educational approaches, at providing financial education specific to individual transactions. Financial transactions are heavily numerical and mathematical. How a given financial transaction might play out can depend on a large number of numerical and other factors, e.g., income, savings, other assets, down payment percentage, expenses, interest rates, taxes, fees, and geographic location. Seemingly small changes in just one or two of these factors can dramatically alter the transaction's outcome.

For example, it can be difficult for the average person to internalize how much a large sum of money actually is, e.g., how much more one million dollars is than one thousand dollars. It can be difficult for a lay person to internalize how an interest rate will impact how much they will owe and when they will owe it on a mortgage or a vehicle they are considering financing, and how that dictates which homes or vehicles they can afford, e.g., how one tenth of a percentage point on an interest rate can make the difference between being able to afford a particular home or vehicle and not being able to afford that home or vehicle. Simply reading these types of information online or on paper, listening to a financial advisor explain this information, or looking at graphical representations of these types of information can be beyond the grasp of the average person. Visualizing aspects of the transactions in an immersive, dynamic metaverse environment in accordance with the present disclosure can close this gap in financial literacy so that the average individual is better informed about their financial transactions, and thereby make better financial decisions.

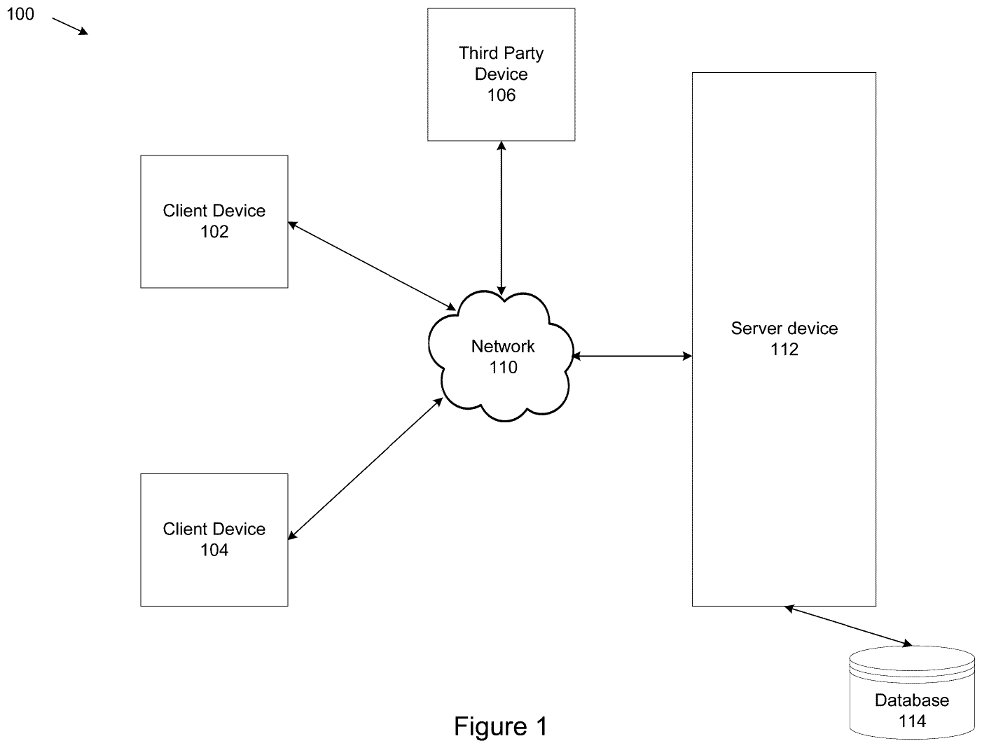

FIG. 1 schematically shows aspects of one example system 100 programmed to provide an immersive metaverse environment for enhancing financial literacy. In this example, the system 100 can be a computing environment that includes a plurality of client and server devices. In this instance, the system 100 includes client devices 102, 104, a third party device 106, a server device 112, and a database 114. The client devices 102, 104 and the third party device 106 can communicate with the server device 112 through a network 110 to accomplish the functionality described herein.

Each of the devices may be implemented as one or more computing devices with at least one processor and memory. Example computing devices include a mobile computer, a desktop computer, a server computer, or one or more other computing devices such as a server farm or cloud computing used to generate or receive data.

For instance, in some examples, the devices include virtual and/or augmented reality devices that facilitate the creation of a metaverse in which individuals can interact. The metaverse can be an immersive world that is facilitated through the use of the virtual and augmented reality devices. Examples of such devices include virtual and/or augmented reality headsets that provide a three-dimensional experience associated with the metaverse.

In some examples, an individual can enter and interact within the metaverse using a virtual representation of themselves. This representation is referred to as an avatar, which is an icon or figure representing the individual. The avatar can be used to interact within the metaverse and can have certain preferences, settings, and options associated therewith.

In some non-limiting examples, the server device 112 is owned by a financial institution, such as a bank. The client devices 102, 104 and the third party device 106 can be programmed to communicate with the server device 112 to generate interactive metaverse environments as described herein. Many other configurations are possible.

The example client device 102 is a virtual reality device (VRD) programmed to access a metaverse and display an environment of the metaverse.

The example client device 104 is an augmented reality device (ARD) programmed to access a metaverse and display an environment of the metaverse.

The system 100 can include more than two client devices with virtual reality and/or augmented reality capabilities. Alternatively, the system 100 can include just one such client device.

The example third party device 106 is programmed to provide a metaverse accessible by the client device 102 and the client device 104. In some examples, the metaverse is provided by another device, such as the server device 112, in which case the system 100 need not include the third party device 106.

The example server device 112 is programmed to generate an environment having immersive, interactive financial literacy enhancement content within a metaverse and/or to augment an existing environment within a metaverse with immersive, interactive financial literacy enhancement content. In some examples, the server device 112 is programmed to generate the metaverse itself. In other examples, the server device 112 is programmed to augment a metaverse generated by another, such as the third party 106.

The example database 114 can include a single database or multiple databases. If the database 114 includes multiple databases, the databases can be centralized or decentralized. The database can store website data (e.g., data obtained from website using a web crawling machine of the server device 112), customer account data, customer profile data, and other data related to financial factors and other factors that impact financial transactions, such as interest rate data, taxes data, legislative data, regulatory data, insurance data, municipal data, real estate zoning data, credit scores data, credit ratings data, home pricing data, home listings data, geographic maps data, vehicle pricing data, vehicle listings data, credit card terms and conditions data, bank account terms and conditions data, investment account terms and conditions data, stock market data, commodities data, other securities data, and so forth.

The server device 112 and the database 114 have access to each other. The database 114 stores data that is accessed and used by the server device 112 to perform the server device's functionality as described herein. The database 114 can be managed by the same entity (e.g., a financial institution) as the server device 112. Alternatively, the database 114 can be a shared database to which the server device 112 has selective, partial access.

The database 114 can store rules, e.g., financial formulae and equations that can be applied by the server device 112 based on financial factors and other factors to calculate outcomes of prospective financial transactions.

The network 110 provides a wired and/or wireless connection between the client devices 102, 104, the third party device 106 and the server device 112. In some examples, the network 110 can be a local area network, a wide area network, the Internet, or a mixture thereof. Many different communication protocols can be used. Although only three devices are shown, the system 100 can accommodate hundreds, thousands, or more of computing devices.

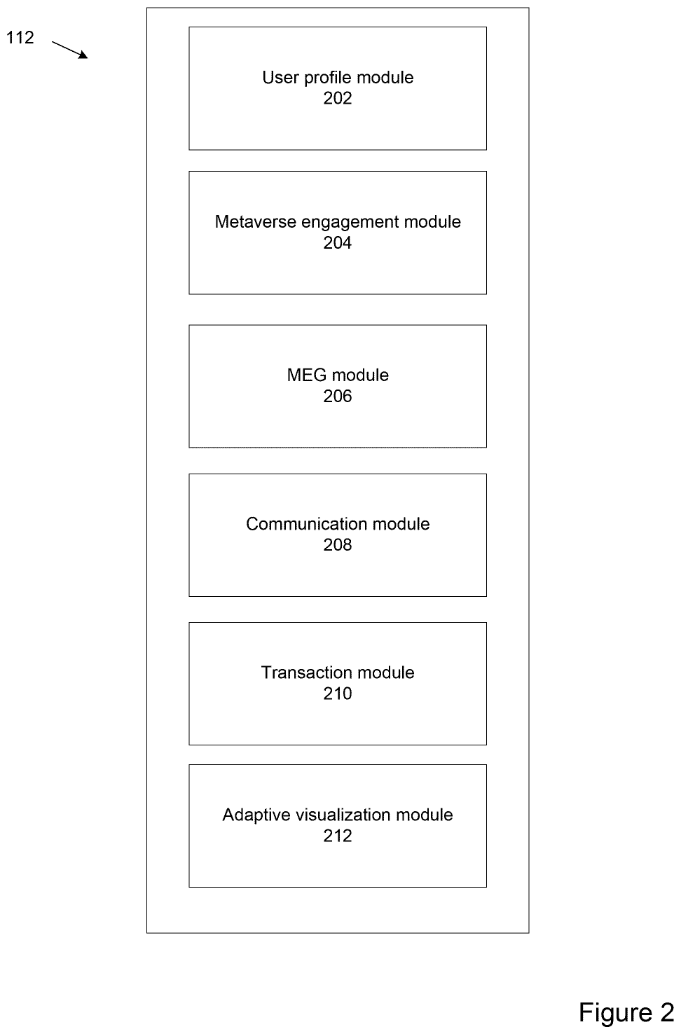

Referring now to FIG. 2, additional details of the server device 112 are shown. In this example, the server device 112 has various logical modules that assist in generating immersive content in a metaverse environment for enhancing financial literacy. The server device 112 can, in this instance, include a user profile module 202, a metaverse engagement module 204, a metaverse environment generation (MEG) module 206, a communication module 208, a transaction module 210, and an adaptive visualization module 212. In other examples, more or fewer modules providing different functionality can be used. If the server device 112 generates its own metaverse, the server device 112 can also include a metaverse generation engine configured to generate a metaverse.

The user profile module 202 is configured to access account information (e.g., bank account information, investment account information) and other personal profile information (e.g., name, address, age, employer, job title, biometric information and other user identity credentials, income, assets, education, family data, etc.) when a metaverse user, such as an avatar of a customer of a financial institution, logs into the financial institution's environment within the metaverse. For example, a customer of a financial institution dons, holds or otherwise engages a metaverse accessing device (MAD) such as an augmented reality device headset or a virtual reality device headset. Using the MAD, the customer logs into the metaverse, thereby activating the customer's avatar within the metaverse.

The avatar can then visit a virtual branch of the financial institution positioned within the metaverse. Upon arrival at the virtual branch, the avatar can be prompted for credentials, e.g., log-in credentials for an account or accounts held by the customer at the financial institution. The user profile module 202 can be configured to generate such prompts for credentials upon the avatar's arrival or other predefined interaction (e.g., opening of a door of the virtual branch) by the avatar with the virtual branch.

The user profile module 202 determines whether the credentials are acceptable. If the credentials are not accepted, the user profile module 202 is configured to deny the avatar access to the financial institution's metaverse environment. If the credentials are accepted, the user profile module 202 is configured to grant the avatar access to the financial institution's metaverse environment. In one example, upon being granted access, the avatar accesses the financial institution's metaverse environment by entering the virtual branch of the financial institution within the metaverse.

Other ways for a user to access the metaverse and for the user's avatar to access the metaverse environment of the financial institution are possible.

The metaverse engagement module 204 is configured to enable the financial institution to access a metaverse as a metaverse environment host. For example, if the metaverse is created by a third party, the metaverse engagement module 204 enables the financial institution to access the metaverse and to have a presence that can serve its customers' or prospective customers' avatars within the metaverse.

Once the metaverse engagement module 204 has gained host environment access to the metaverse, the MEG module 206 is configured to generate (e.g., to build) an environment within the metaverse that is specific to the financial institution. Thus, for example, the MEG module 206 is configured to generate the virtual branch (or another environment through which an avatar can initiate and be involved in financial literacy exercises) within the metaverse and all the visual audial, and interactive features that accompany that environment. For instance, if the environment includes a visualization of a branch of the financial institution, then the MEG module 206 can generate a visualization of the exterior of the branch building, a visualization of the interior of the branch building once the avatar gains access, as well as the communication, transactional, and other visualizations specific to the financial institution's metaverse environment, as described herein.

The communication module 208 is configured to communicate with an avatar that has been granted access to the financial institution's virtual environment. Communication can be performed in any suitable manner, such as with a chat box or with an avatar virtual agent of the financial institution. The communication module 208 can provide live communications, or automatically generated communications selected based on requests and other inputs provided by the user's avatar within the financial institution's virtual environment. Thus, the communication module 208 is configured to determine a reason for the user's avatar's visit to the financial institution's virtual environment and, based on communications from the user's avatar, to identify a prospective transaction or prospective transaction type that the user's avatar may be considering and/or seeking advice for.

The transaction module 210 is configured to determine the financial factors and other factors that are relevant to executing the identified prospective transaction and to determine different outcomes of the identified prospective transaction based on different values of the determined factors. The transaction module 210 can be configured to retrieve values for the various factors from the database 114 (FIG. 1), or from other locations. The transaction module 210 can plug the factors' values into one or more equations based on rules stored on the server 112 or the database 114 (FIG. 1) to generate a result of the prospective transaction. Data relating to the result (e.g., specific homes for sale, specific vehicles for sale, specific credit cards with specific terms and conditions that are available), can also be retrieved by the server from the database 114 (FIG. 1) and associated with the prospective transaction

For example, the result generated by the transaction module 210 can be numerical, such as a maximum price of a home that can be afforded by the user corresponding to the avatar that has requested transactional advice, based on that user's personal profile data.

As another example, the result generated by the transaction module 210 can be an identification of a credit card with optimal credit terms based in part on the personal profile data (e.g., spending habits and preferences, income) of the user corresponding to the avatar.

As another example, the result generated by the transaction module 210 can be an identification of five different used vehicles available for purchase within a predefined radius of the user's address that, based in part on the user's profile data, the user would be interested in purchasing (e.g., based on vehicle preference data input by the avatar or stored as user profile data) and can afford to purchase (e.g., based on the user's financial position).

Using data available to it (e.g., data stored in the database 114), the adaptive visualization module 212 is configured to generate easily comprehensible and dynamic visualizations within the financial institution's metaverse environment that represent a result of the prospective transaction as determined by the transaction module 210.

For example, the adaptive visualization module 212 can generate a visualization of a home that can be purchased by the user whose avatar is seeking advice about a prospective home purchase transaction.

As another example, the adaptive visualization module 212 can generate a visualization of vehicle or vehicles that can be purchased or leased by the user whose avatar is seeking advice about a prospective vehicle lease or purchase transaction.

In some examples, the adaptive visualization module 212 can generate a visualization that provides quantitative perspective, such as a first object that represents a first amount (e.g., a first pile of money that represents a down payment amount) and second object that represents a second amount (e.g., a second pile of money) next to the first object that is proportionally sized larger that than the first object to represent how much larger the second amount is than the first amount (e.g., how much greater the balance on the loan plus interest is after the down payment is compared with the down payment).

In some examples, the dynamic visualizations are also interactive with the avatar. For example, the avatar is able to enter the visualized home and view different rooms within the home, to visually explore a floor plan of the home, to enter a vehicle and view interior aspects of the vehicle. Features of the objects being visualized, such as horsepower and fuel efficiency of a vehicle, or the age, address, and plot size of a home, or the terms and conditions of a credit card, can be displayed within the metaverse environment, e.g., adjacent to or overlaying the object they describe.

The adaptive visualization module 212 is also configured to generate, within the financial institutions' metaverse environment, visualizations of one or more interactive adjusters, such as toggles, switches, slide bars, knobs, dials, data entry fields, and so forth. The avatar can interact with such an adjuster (e.g., by sliding or rotating the adjuster) to adjust a value of one of the factors (e.g., a financial factor) of the financial transaction for which advice is being sought. Based on the input adjustment, the transaction module 210 re-executes the transaction with the updated factor to generate an updated transaction result, and the adaptive visualization module 212 generates a new dynamic visualization that replaces or is placed within the metaverse environment together with and supplementing the prior visualization, that represents the updated result.

For example, the avatar seeking advice about a prospective home purchase can be presented within the metaverse environment with a slide bar adjuster for adjusting a mortgage interest rate. Initially, the adjuster can be set to a default value (e.g., 4.0 percent), based on user profile information such as income, assets, credit score, and geographic location, and other data such as the interest rate set by the Federal Reserve. Included in this initial transaction-specific metaverse environment is a visualization (e.g., a three-dimensional, interactive visualization) of an actual first home or a representative first home that the user corresponding to the avatar could afford based on various financial factors, including the default 4.0 percent mortgage interest rate. The avatar then adjusts the slide bar to 3.8 percent.

In response, the adaptive visualization module 212 replaces the first home visualization or positions together with the first home visualization, within the metaverse environment, a visualization (e.g., a three-dimensional, interactive visualization) of a second home that is different from the first home and that has a higher market value than the first home (e.g., the second home is a larger home than the first home, and/or the second home has a larger plot of land than the first home, and/or the second home is located in a quieter neighborhood than the first home, and/or the second home is newer and/or in better condition than the first home).

Because of these immersive, interactive visualizations generated by the adaptive visualization module 212, the avatar, and the user corresponding to the avatar, can more easily grasp, in concrete terms, an impact of a 0.2 percent difference in the mortgage interest rate.

The avatar can then proceed, within the metaverse environment of the financial institution, to drill down further to understand more about the prospective transaction. For example, via the communication module 208, the avatar can inquire within the metaverse environment of the financial institution, how a 0.2 percent interest rate reduction to 3.8 percent may be obtained. In response, the server 112, e.g., via the communication module 208, the transaction module 210 and/or the adaptive visualization module 212, can provide, within the metaverse environment, a textual response, an audio response, and/or another visualization that responds to the avatar's inquiry.

For instance, the response can include a suggestion to wait three months for the markets to change, or to find a way to increase a credit score by 20 points. The response can include an immersive visualization representing recommendation or suggestion, such as a calendar with a date circled on it corresponding to when the avatar and corresponding user should consider revisiting the prospective transaction.

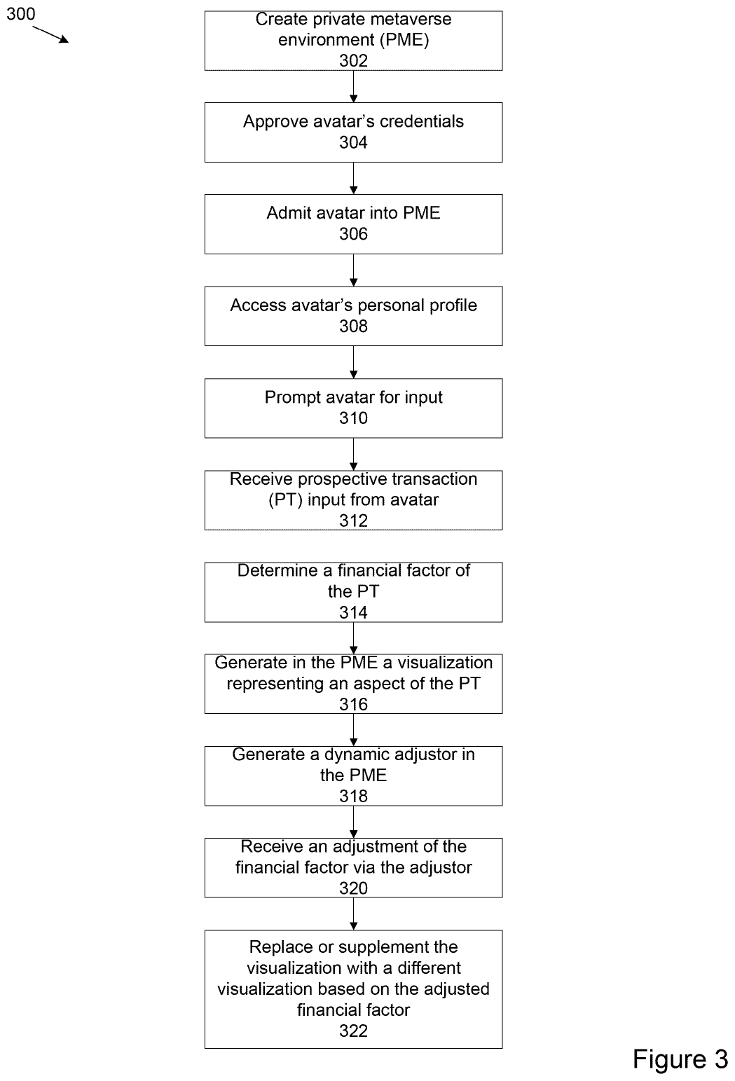

FIG. 3 shows an example method 300 that can be performed using the system 100, or one or more portions thereof, of FIG. 1. Embodiments of methods according to the present disclosure need not include all of the steps of FIG. 300. In some embodiments, the steps can be performed in a different order.

At a step 302 of the method 300, a private metaverse environment (PME) is created. For example, the server 112 (FIG. 1) augments an existing metaverse with a private environment (e.g., in the form of a virtual branch of a financial institution) with restricted access to avatars whose corresponding users have accounts with (e.g., are existing customers of) the financial institution.

At a step 304 of the method 300, an avatar's credentials are approved by the server 112 (FIG. 112). For example, the avatar approaches the PME and requests access to the PME, and then inputs credentials (e.g., biometric information of the corresponding user, a login name, a password) that are approved. The avatar can also be automatically approved for entry to the PME when the user corresponding to the avatar logs into their MAD (e.g., after donning a virtual reality headset or an augmented reality headset).

At a step 306 of the method 300, the authorized avatar is admitted to the PME. For example, the avatar enters the virtual branch of the financial institution.

At a step 308 of the method 300, the server 112 (FIG. 1) accesses personal profile data about the avatar or the user corresponding to the avatar.

At a step 310 of the method 300, the avatar within the PME is prompted for input so that the server 112 (FIG. 1) can understand what prospective transaction (PT) the avatar would like to have a better understanding of. For example, an avatar corresponding to a bank employee can approach the customer avatar and ask, via text or audibly, how they can assist.

At a step 312 of the method 300, the avatar corresponding to the customer inputs, e.g., via speech that is automatically processed with natural language understanding protocols, or via text, a description or identification of a type of PT the customer avatar is interested in, such as a home purchase, a vehicle purchase, an investment, a new credit card, and so forth. This PT information is received, processed and understood by the server 112 (FIG. 1).

At a step 314 of the method 300, the server 112 (FIG. 1) determines one or more factors, including at least one financial factor, of the PT. For example, if the PT is a home purchase, at the step 312 the server 112 (FIG. 1) determines that financial factors of that PT include down payment amount, mortgage interest rate, credit score, income amount, mortgage duration, and so forth. At the step 314 the server 112 can also determine one or more non-financial factors of the PT, such as the zip code where the user lives or would like to move to, the user's age, the size of the user's family, whether the user has any pets, the location of the user's employer, and so forth. Each of the factors (both financial and non-financial) can impact the result of the PT according to predefined rules and/or formulae stored in the database 114 (FIG. 1) that the server 112 processes.

At a step 316 of the method 300, the adaptive visualization module 212 (FIG. 2) of the server 112 (FIG. 1) generates in the PME a visualization representing an aspect of the PT. The aspect is selected by the adaptive visualization module 212 (FIG. 2) based on a type of the PT (e.g., a home purchase type, a personal loan type, a new credit card type, a vehicle financing type, etc.) and one or more financial factors of the PT.

The visualization is selected by the adaptive visualization module 212 (FIG. 2) based on the aspect (e.g., a home is selected based on the aspect) and the one or more financial factors (e.g., a home that can be afforded by the user is selected based on the one or more financial factors), and also based on a literacy factor. For example, the personal profile data of the user can include financial literacy data specific to the user. Over time, as the user is exposed more to the immersive financial literacy content of the PME, the financial literacy data can be updated to reflect increases in that user's financial literacy. For example, financial literacy can be scored on a scale of 1 through 5, with 1 representing extremely little comfort with finances, and 5 representing a financial expert, e.g., an accountant or a banker.

The user profile module 202 (FIG. 2) can score the user (and corresponding avatar) for financial literacy based on user profile data, such as job type, level of education, prior interactions between the financial institution and the user, number and/or type of prior financial literacy enhancement engagements by the user with the PME, and so forth. For example, for each predefined number (e.g., 5) of financial literacy enhancement engagements of the user with the PME, the financial literacy score for that user can be increased by 1.

The adaptive visualization module 212 (FIG. 2) maps a combination of the financial literacy score and the PT aspect to a visualization. For example, for a PT aspect that is a home purchase type and a user having a financial literacy of 1 out of 5, a representative home that can be afforded by the user is selected as the visualization, without any specific reference to any financial factors or numbers. In contrast, for a PT aspect that is a home purchase type and a user having a financial literacy of 2 out of 5, a representative home that can be afforded by the user is selected as the visualization including visualizations of one or more financial factors (e.g., mortgage interest rate, personal income, down payment amount) that went into determining that that home is affordable. However, the visualizations of the one or more financial factors, rather than including numbers or percentages, can include graphical representations of amounts, such as images of piles of money. For a user having a financial literacy of 3 out of 5, numbers can be introduced to the visualization.

These are just some examples. Many different methods can be employed to evaluate and score financial literacy, and then map the scored financial literacy to an appropriate metaverse environment visualization that is selected based also on the PT aspect.

In some embodiments, the method 300 can also include one or more of the steps 318, 320, and 322.

At the step 318 of the method 300, the adaptive visualization module 212 (FIG. 2) of the server 112 (FIG. 1) generates a dynamic adjuster of a financial factor (e.g., annual percentage rate (APR)) of the PT in the PME together with the rest of the visualization.

At a step 320 of the method 300, the avatar adjusts the adjuster and the corresponding adjustment of the financial factor value is received by the server 112 (FIG. 1).

Alternatively, the financial factor adjusts automatically without input from the avatar, e.g., in response to a benchmark rate increase by the Federal Reserve, or in response to the user's starting a new job with higher income. An automatic change in a financial factor of the PT can occur between metaverse engagements by the user. For example, the user engages the PME on a Monday and logs out having viewed one visualization of the PT, the Federal Reserve adjusts the benchmark interest rate on Tuesday, and the user logs back in to the metaverse and enters the PME on Wednesday, at which point the updated visualization will be generated in the PME rather than the visualization generated during the avatar's previous visit on Monday.

At a step 322 of the method 300, the adaptive visualization module 212 (FIG. 2) of the server 112 (FIG. 1) replaces or supplements the prior visualization with a different visualization based on the adjusted financial factor.

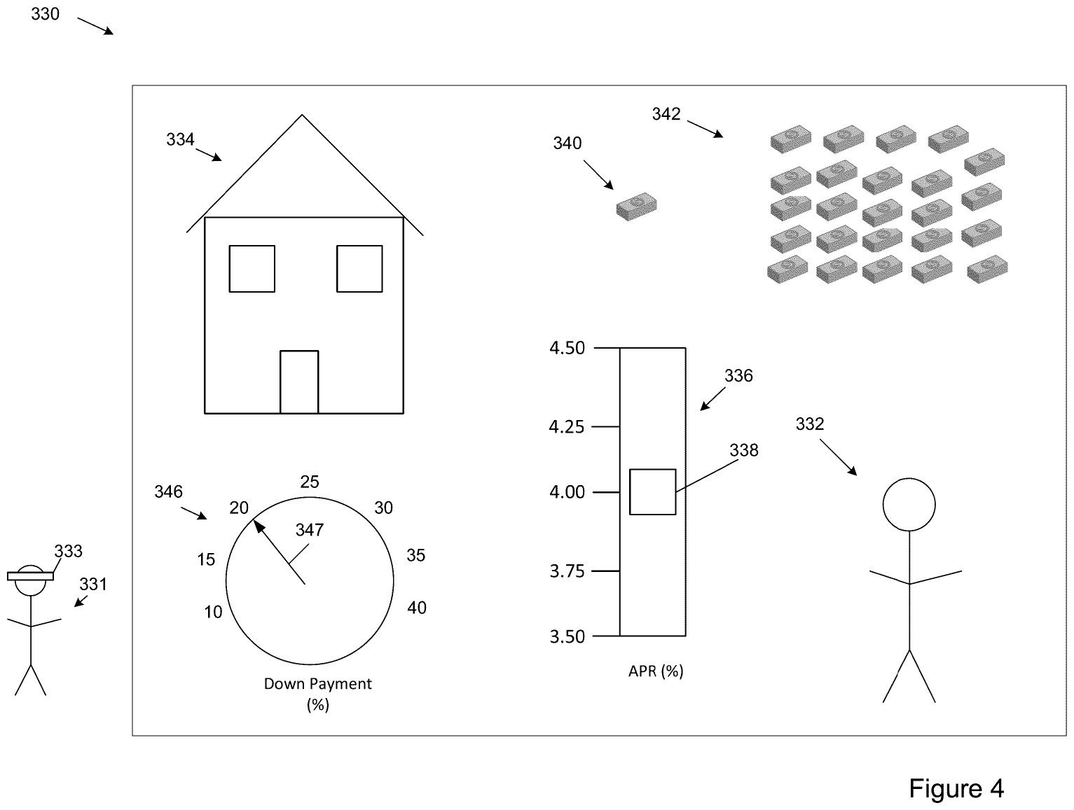

FIG. 4 shows a schematic representation of an example metaverse environment 330 generated by the system of FIG. 2.

The environment 330 can be a private limited access environment hosted by a financial institution within a metaverse. For example, the environment 330 can be configured to resemble the interior of a branch of the financial institution. The environment 330 can be viewable with a MAD 333 worn by a user 331.

The environment 330 is generated in response to receiving an input by the user's avatar 332 within the environment 330 regarding a prospective home purchase. That is, the avatar 332 has indicated within the PME that it is interested in possibly purchasing a home.

The environment 330 includes visualizations based on the prospective transaction (home purchase), financial factors of the prospective transaction, and the known financial literacy of the user 331 corresponding to the avatar 332.

For example, the environment 330 includes a dynamic visualization of a home 334 that, based on various financial and other factors (e.g., geographic factors), the user 331 may wish to purchase and can be afforded by the user. In some examples, the home 334 is three dimensional and interactive. For example, within the PME 330 the avatar 332 can enter the home 334, tour rooms within the home 334, view a floorplan of the home 334, etc. In some examples, the home 334 is a representation of an actual home that is not for sale. In some examples, the home 334 is a representation of an actual home that is for sale. In some examples, the home 334 is a representation of a generic home that represents a typical type of home that could be afforded by the user 331 (e.g., based on the square footage, plot size, location, and number of bedrooms and bathrooms), but that is not an actual existing home. The visualizations 334 can help the user 331 better appreciate the type of home they can afford, without delving into too many different financial factors or numbers, thereby gently enhancing the user's financial literacy.

The environment 330 includes two dynamic financial factor adjusters, including an APR slide bar 336 with an adjuster element 338 and a down payment dial 346 with an adjustment element 347. The home 334 that has been selected for the visualization has been selected, in part, based on a presumed APR of 4.00 percent, and a down payment of 20 percent of the market value or listed price of the home. The adjusters 336 and 346 can be adjusted to different values by the avatar 332 within the environment 330.

The environment 330 also includes quantitative perspective visualizations 340 and 342 that visualize for the avatar 332, without using numerical figures, how much more the balance plus interest on the mortgage will be (represented by the money stacks 342) compared to the down payment (represented by the money stack 340). The visualizations 340 and 342 can help the user 331 better appreciate how much debt they will be in even after making a substantial down payment, thereby gently enhancing the user's financial literacy.

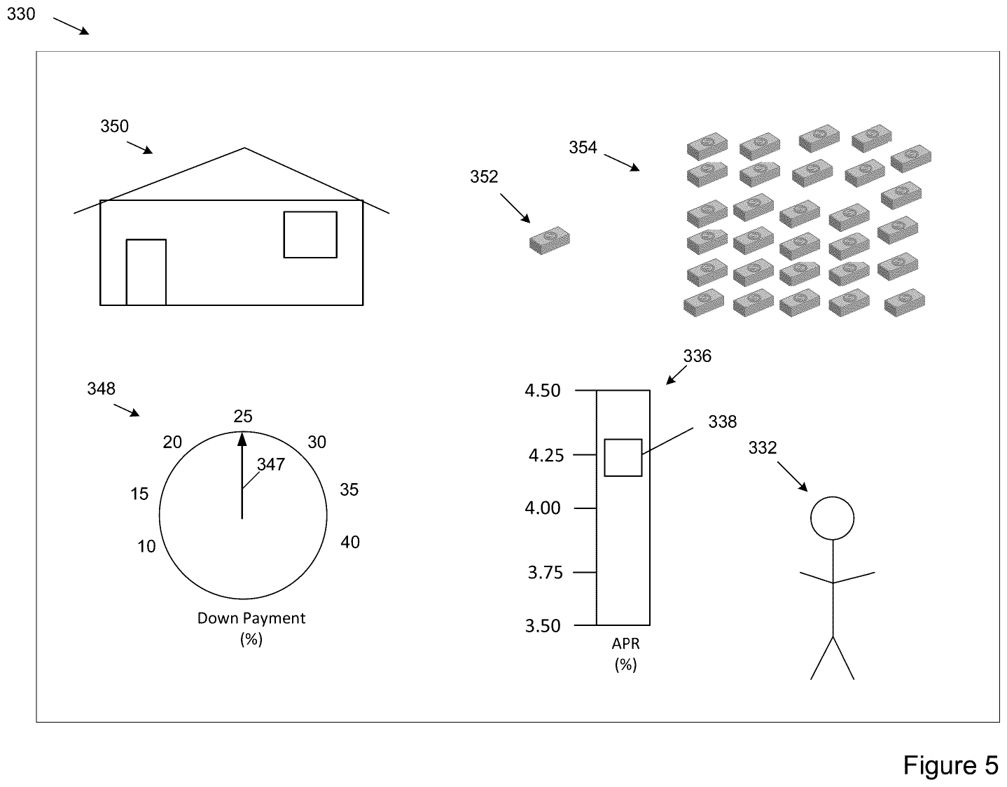

FIG. 5 shows a further schematic representation of the metaverse environment 330 of FIG. 4. In FIG. 4, the avatar 332 adjusts (e.g., by reaching out its hand and grasping or touching the adjustment elements 338 and 347) the APR adjustment element 338 and the down payment adjustment element 347 by increasing both of them, resulting in changes to the metaverse environment 330 as reflected in FIG. 5. Specifically, due to changes in financial factors (APR and down payment) selected by the avatar 332, the visualization of the home 334 has been replaced (in other examples, supplemented) within the environment 330 with a different dynamic visualization of a different home 350 that has a lower market value than the home 334 of FIG. 4 and that the user could therefore afford despite the changes in financial factors of the prospective transaction.

In some examples, the home 350 is three dimensional and interactive. For example, within the PME 330 the avatar 332 can enter the home 350, tour rooms within the home 350, view a floorplan of the home 350, etc. In some examples, the home 350 is a representation of an actual home that is not for sale. In some examples, the home 350 is a representation of an actual home that is for sale. In some examples, the home 350 is a representation of a generic home that represents a typical type of home that could be afforded by the user, but that is not an actual existing home. The visualization of the home 350 can help the user better appreciate the type of home they can afford with the revised APR and down payment, without delving into too many different financial factors or numbers, thereby gently enhancing the user's financial literacy.

Due to the adjustments of financial factors made by the avatar 332, the quantitative perspective visualizations have also been changed in FIG. 5 to visualizations 352 and 354, which visualize for the avatar 332, without using numerical figures, how much more the balance plus interest on the mortgage will be (represented by the money stacks 354) compared to the down payment (represented by the money stack 352) with the updated APR and down payment. The visualizations 352 and 354 can help the user 331 better appreciate how much debt they will be in even after making a more substantial down payment, thereby gently enhancing the user's financial literacy. In particular, even though the down payment is increased in this scenario, the amount of balance plus interest thereafter has increased. In this manner, the dynamic graphically quantitative perspective visualizations can help the user appreciate the high significance of even small changes in the APR and the relative importance of such changes to the amount of down payment.

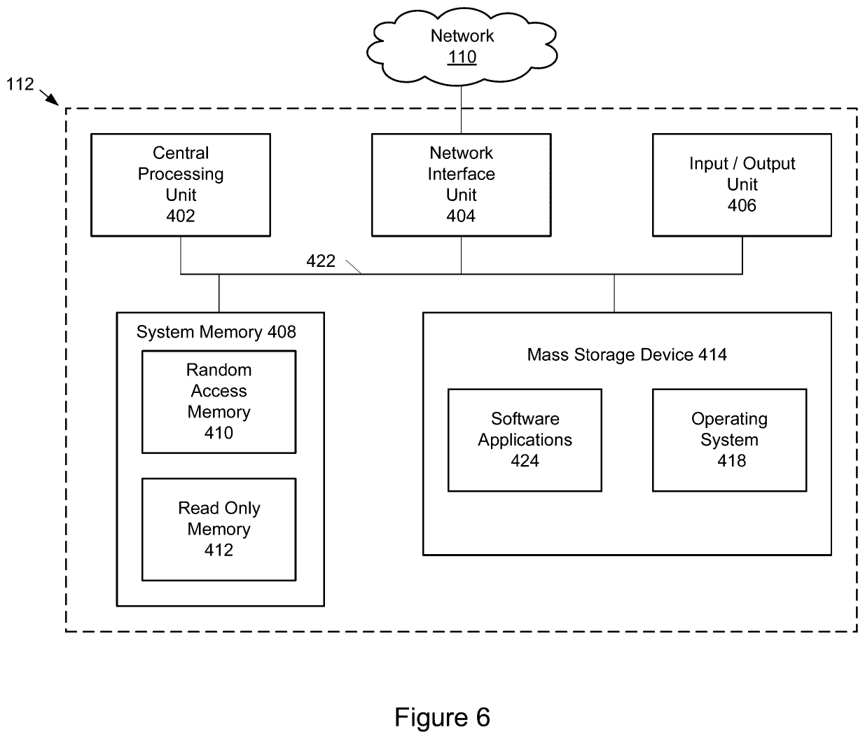

FIG. 6 shows example physical components of the server device 112 of FIG. 2.

As illustrated in the embodiment of FIG. 6, the example server 112, which provides the functionality described herein, can include at least one central processing unit (“CPU”) 402, a system memory 408, and a system bus 422 that couples the system memory 408 to the CPU 402. The system memory 408 includes a random access memory (“RAM”) 410 and a read-only memory (“ROM”) 412. In some examples, the memory or portions thereof can include the database 114 (FIG. 1). A basic input/output system containing the basic routines that help transfer information between elements within the server device 112, such as during startup, is stored in the ROM 412. The server device 112 further includes a mass storage device 414. The mass storage device 414 can store software instructions and data. A central processing unit, system memory, and mass storage device similar to that shown can also be included in the other computing devices disclosed herein.

The mass storage device 414 is connected to the CPU 402 through a mass storage controller (not shown) connected to the system bus 422. The mass storage device 414 and its associated computer-readable data storage media provide non-volatile, non-transitory storage for the server device 112. Although the description of computer-readable data storage media contained herein refers to a mass storage device, such as a hard disk or solid-state disk, it should be appreciated by those skilled in the art that computer-readable data storage media can be any available non-transitory, physical device, or article of manufacture from which the central display station can read data and/or instructions.

Computer-readable data storage media include volatile and non-volatile, removable, and non-removable media implemented in any method or technology for storage of information such as computer-readable software instructions, data structures, program modules, or other data. Example types of computer-readable data storage media include, but are not limited to, RAM, ROM, EPROM, EEPROM, flash memory or other solid-state memory technology, CD-ROMs, digital versatile discs (“DVDs”), other optical storage media, magnetic cassettes, magnetic tape, magnetic disk storage or other magnetic storage devices, or any other medium which can be used to store the desired information and which can be accessed by the server device 112.

According to various embodiments of the invention, the server device 112 may operate in a networked environment using logical connections to remote network devices through network 110, such as a wireless network, the Internet, or another type of network. The server device 112 may connect to network 110 through a network interface unit 404 connected to the system bus 422. It should be appreciated that the network interface unit 404 may also be utilized to connect to other types of networks and remote computing systems. The server device 112 also includes an input/output controller 406 for receiving and processing input from a number of other devices, including a touch user interface display screen or another type of input device. Similarly, the input/output controller 406 may provide output to a touch user interface display screen or other output devices.

As mentioned briefly above, the mass storage device 414 and the RAM 410 of the server device 112 can store software instructions and data. The software instructions include an operating system 418 suitable for controlling the operation of the server device 112. The mass storage device 414 and/or the RAM 410 also store software instructions and applications 424, that when executed by the CPU 402, cause the server device 112 to provide the functionality of the server device 112 discussed in this document.

Although various embodiments are described herein, those of ordinary skill in the art will understand that many modifications may be made thereto within the scope of the present disclosure. Accordingly, it is not intended that the scope of the disclosure in any way be limited by the examples provided.

1. A computer system for enhancing financial literacy, comprising:
one or more processors; and
non-transitory computer-readable storage media encoding instructions which, when executed by the one or more processors, causes the computer system to:
when the computer system is operatively linked to a metaverse accessing device (MAD), receive log-in credentials;
when the computer system is operatively linked to the MAD, create a metaverse environment with the MAD, the MAD being one of a virtual reality device or an augmented reality device, the metaverse environment including a visualization of an object and a visualization of an adjuster configured to be moved by an avatar within the metaverse environment, the object representing an aspect of a prospective financial transaction, wherein the visualization of the object is selected by the computer system, while the computer system is operatively linked to the MAD, from a plurality of object visualizations, with selection being based on:
a financial factor of the prospective financial transaction; and
a financial literacy score associated with the avatar, the financial literacy score being based on a number of log-ins to the metaverse environment, via the MAD, in which the avatar enters a virtual branch of the financial services institution within the metaverse environment, the number of log-ins being determined based on receipt of the log-in credentials;
when the computer system is operatively linked to the MAD, receive a modification of the financial factor based on a movement of the adjuster by the avatar;
when the computer system is operatively linked to the MAD, visually modify the visualization of the object based on the modification of the financial factor to provide a modified visualization of the object within the metaverse environment;
increase the financial literacy score to provide an increased financial literacy score, the increase being in response to an additional log-in to the metaverse environment, via the MAD, in which the avatar gains a further entry into the virtual branch of the financial services institution within the metaverse environment;
when the computer system is operatively linked to the MAD during the additional log-in to the metaverse environment, select a different one of the plurality of object visualizations based on the increased financial literacy score;
when the computer system is operatively linked to the MAD during the additional log-in to the metaverse environment, generate the different one of the plurality of object visualizations within the metaverse environment; and
when the computer system is operatively linked to the MAD during the additional log-in to the metaverse environment, identify a physical object for a transaction, the physical object and the transaction corresponding to the different one of the plurality of object visualizations.

2. (canceled)

3. The computer system of claim 1,
wherein the prospective financial transaction is a purchase of a home;
wherein the financial factor includes a value of one of a mortgage interest rate, a personal income amount, and a credit score; and
wherein the visualization of the object includes a visual representation of a home, the home being selected for the visualization of the object based on the financial factor.

4. The computer system of claim 3,
wherein the home is selected for the visualization of the object based on a location; and
wherein the visual representation is representative of an actual home at the location.

5. The computer system of claim 4, wherein the actual home is for sale.

6. The computer system of claim 3, wherein visually modify the visualization of the object includes to replace the visual representation of the home with a visual representation of a different home.

7. The computer system of claim 6, wherein receive the modification occurs when the metaverse environment is being displayed with the MAD.

8. (canceled)

9. The computer system of claim 1, wherein the metaverse environment includes a visual representation of a branch of a financial services institution.

10. The computer system of 9, wherein the object appears only after an avatar corresponding to a user of the MAD enters the branch of the financial services institution within the metaverse environment.

11. A computer-implemented method for enhancing financial literacy, comprising:
receiving log-in credentials;
creating a metaverse environment with a metaverse accessing device (MAD), the MAD being one of a virtual reality device or an augmented reality device, the metaverse environment including a visualization of an object and a visualization of an adjuster configured to be moved by an avatar within the metaverse environment, the object representing an aspect of a prospective financial transaction, wherein the visualization of the object is selected by a computer system, while the computer system is operatively linked to the MAD, from a plurality of object visualizations, with selection being based on:
a financial factor of the prospective financial transaction; and
a financial literacy score associated with the avatar, the financial literacy score being based on a number of log-ins to the metaverse environment, via the MAD, in which the avatar enters a virtual branch of the financial services institution within the metaverse environment, the number of log-ins being determined based on receipt of the log-in credentials;
when the computer system is operatively linked to the MAD, receiving a modification of the financial factor based on a movement of the adjuster by the avatar;
when the computer system is operatively linked to the MAD, visually modifying the visualization of the object based on the modification of the financial factor to provide a modified visualization of the object within the metaverse environment;
increasing the financial literacy score to provide an increased financial literacy score, the increasing being in response to an additional log-in to the metaverse environment, via the MAD, in which the avatar gains a further entry into the virtual branch of the financial services institution within the metaverse environment;
when the computer system is operatively linked to the MAD during the additional log-in to the metaverse environment, selecting a different one of the plurality of object visualizations based on the increased financial literacy score;
when the computer system is operatively linked to the MAD during the additional log-in to the metaverse environment, generating the different one of the plurality of object visualizations within the metaverse environment; and
when the computer system is operatively linked to the MAD during the additional log-in to the metaverse environment, identifying a physical object for a transaction, the physical object and the transaction corresponding to the different one of the plurality of object visualizations.

12. The computer-implemented method of claim 11, wherein the object is associated with a prospective financial transaction.

13. The computer-implemented method of claim 12,
wherein the prospective financial transaction is a purchase of a home;
wherein the financial factor includes a value of one of a mortgage interest rate, a personal income amount, and a credit score; and
wherein the visualization of the object includes a visual representation of a home, the home being selected for the visualization of the object based on the financial factor.

14. The computer-implemented method of claim 13, wherein visually modifying the visualization of the object includes replacing the visual representation of the home with a visual representation of a different home.

15. The computer-implemented method of claim 14, wherein receiving the modification occurs when the metaverse environment is being displayed with the MAD.

16. (canceled)

17. The computer-implemented method of claim 11, wherein the metaverse environment includes a visual representation of a branch of a financial services institution.

18. The computer-implemented method of claim 17, wherein the object appears only after an avatar corresponding to a user of the MAD virtually enters the branch of the financial services institution within the metaverse environment.

19. A system for enhancing financial literacy, comprising:
a metaverse accessing device (MAD), including a virtual reality device or an augmented reality device;
one or more processors; and
non-transitory computer-readable storage media encoding instructions which, when executed by the one or more processors, causes the MAD to:
receive log-in credentials;
generate a metaverse environment including a visualization, the visualization including a home, the visualization being selected from a plurality of object visualizations based on a financial literacy score associated with an avatar, the financial literacy score being based on a number of log-ins to the metaverse environment, via the MAD, in which the avatar enters a virtual branch of the financial services institution within the metaverse environment, the number of log-ins being determined based on receipt of the log-in credentials, the home being selected for the visualization based on financial factors including a personal income amount and a mortgage interest rate, the metaverse environment including a visualization of a dynamic adjuster configured to be moved by the avatar within the metaverse environment to adjust by the avatar, a value of one of the financial factors;
generate a visualization of a different home within the metaverse environment, the different home being selected based on a movement of the adjuster by the avatar within the metaverse environment;
receive an additional log-in to the metaverse environment in which the avatar gains a further entry into the virtual branch of the financial services institution within the metaverse environment;
select, during the additional log-in to the metaverse environment, a different one of the plurality of object visualizations based on an increased financial literacy score, the increased financial literacy score being based on receipt of the additional log-in to the metaverse environment;
generate the different one of the plurality of object visualizations within the metaverse environment; and
identify a physical object for a transaction, the physical object and the transaction corresponding to the different one of the plurality of object visualizations.

20. The system of claim 19, wherein the visualization of the different home replaces the visualization of the home within the metaverse environment.
